(19) United States
(12) Patent Application Publication
(10) Pub. No.: US 2026/0138065 A1
(43) Pub. Date: May 21, 2026

(54) Rotary Disc Filter Having a High Pressure Media Cleaning System

(71) Applicant: Veolia Water Solutions & Technologies Support, Saint-Maurice (FR)

(72) Inventor: Johan Gustav Alexander Jibert, Oxie (SE)

(21) Appl. No.: 19/119,477

(22) PCT Filed: Sep. 28, 2023
(86) PCT No.: PCT/IB2023/059711

§ 371 Date: Apr. 9, 2025

Related U.S. Application Data
(60) Provisional application No. 63/414,984, filed on Oct. 11, 2022.

(51) Int. Cl. B01D 33/46; B01D 33/21; B01D 33/50; B01D 33/80

(52) U.S. Cl. CPC B01D 33/463; B01D 33/21; B01D 33/503; B01D 33/804; B01D 2201/084

(57) ABSTRACT

A rotary disc filter designed to remove suspended solids from wastewater is provided with a high pressure media cleaning system. The high pressure media cleaning system comprises a sectioned manifold that extends along the side of an array of disc-shaped filter units. The sectioned manifold includes a plurality of hydraulic sections with each hydraulic section isolated from the other hydraulic section or sections. Communicatively connected to each hydraulic section is a plurality of spray bars that include nozzles. The spray bars communicatively connected to a particular hydraulic section is designated to clean only a section of the filter units at any one time. Pressurized water is supplied to one hydraulic section at a time. The pressurized water enters the hydraulic section and from the hydraulic section flows through the respective spray bars communicatively connected thereto and out the nozzles of the spray bars and in the process cleans filter media that form a part of the filter unit of a particular filter unit section.

### FIELD OF THE INVENTION

The present invention relates to rotary disc filters used for filtering wastewater and water, and more particularly to rotary disc filters having a high pressure media cleaning system used to restore the capacity of the filter media.

### BACKGROUND OF THE INVENTION

Rotary disc filters of the type described here are designed to filter wastewater and water (hereafter collectively referred to as “wastewater”). They typically include a drum and a plurality of filter discs or units mounted on the drum. Each filter unit includes media that filters the wastewater as it passes through the filter units. As wastewater passes through the filter units, suspended solids contained in the wastewater are captured in the media. To clean or remove suspended solids from the media, rotary disc filters typically include a backwashing system that is employed from time-to-time to dislodge and remove suspended solids from the media. In practice, backwashing systems are frequently used during the operation of a rotary disc filter. While conventional backwashing operations are important and serve a valuable function, the filter media over a period of time can still become clogged and loose its capacity to efficiently filter the wastewater passing through the filter units. This is sometimes referred to as long term media clogging. Often it is noticeable after the media has been used several months. Moreover, clogging can also occur due to a sudden failure in an upstream treatment process. In any event, over time one can anticipate that the media will become less efficient despite frequent and regular backwashing.

It is known to supplement conventional backwashing operations with less frequent media cleaning with what is referred to herein as a high pressure media cleaning system. Compared to conventional backwashing, high pressure media cleaning aims at restoring the filtering capacity of the media and is typically employed less frequently than conventional backwashing.

One approach to high pressure media cleaning entails a carriage mounted on the disc filter and moveable along one side of the filter units. This approach is described in U.S. Pat. No. 8,444,862, the disclosure of which is expressly incorporated herein by reference. Mounted on the carriage are two spaced apart spray bars or arms that are pivoted from an inoperative position outside of the filter units to an operative position where the two spray bars project along opposite sides of a filter unit. Once in the operative position, high pressure cleaning water is directed out nozzles associated with the spray bars onto opposite sides of the filter unit. During this cleaning operation, the spray bars can be articulated so as to clean various areas of the filter unit that the spray bars straddle. Once the filter unit is cleaned, the two spray bars are retracted to the inoperative position and the carriage is incremented to the next adjacent filter unit and the cleaning process continues. This has proven to be an unreliable approach to high pressure media cleaning. The precision required to increment the carriage to precisely align with each filter unit and at the same time control the positioning and movement of the spray bars and associated nozzles in order to efficiently clean the filter unit is challenging. This is even more challenging today as there is a trend to position the filter units closer and closer together to increase footprint efficiency.

Another approach entails a high pressure cleaning system that includes a separate spray bar and nozzle for each filter unit. In this case, each spray bar includes two nozzles. When projected between two adjacent filter units, each nozzle of the spray bar cleans one side of two adjacent filter units. The problem or shortcoming here is that a separate flow control valve and high pressure hose and fitting is required for each spray bar. That is, if the disc filter includes 22 filter units, this means that there are 23 flow control valves mounted on the disc filter and 23 high pressure hoses and fittings that extend from the flow control valves to the respective spray bars. As a practical matter, the cost of the flow control valves and the high pressure hoses and fittings makes it difficult to justify this approach for disc filters having more than 12 filter units, for example.

### SUMMARY OF THE INVENTION

The present invention aims to overcome the disadvantages and drawbacks of such high pressure media cleaning systems by providing a high pressure media cleaning system for a disc filter that minimizes flow control valves, hoses and conduits, and fittings, yet cleans a large number of filter units one section at a time where each section includes a multiplicity of filter units.

To achieve this, the disc filter is provided with a sectioned manifold that extends along one side of the filter units. Formed in the sectioned manifold is a plurality of hydraulic sections, each hydraulic section being isolated from the other section or sections. Spray bars, which include nozzles, are communicatively connected to each of the hydraulic sections and project therefrom into areas between the respective filter units. More particularly, the spray bars are grouped with each group being communicatively connected to a particular hydraulic section of the manifold. A pressurized water supply unit is provided and is configured to supply pressurized water to one hydraulic section at a time. Pressurized water enters the hydraulic section and is directed into the associated spray bars and out the nozzles thereof onto the adjacent filter media. The manifold which supports the spray bars is rotated, which results in the nozzles sweeping along the sides of the filter units as the filter units are rotated. This assures that substantially all of the filter media is cleaned.

In one embodiment, the high pressure media cleaning system is automated. That is, the disc filter and the pressurized water supply unit is configured (i.e., designed to) to sequentially clean one section of filter units after another. In this example, the pressurized water supply unit includes a pump, and a pressurized water outlet and flow control valve for each hydraulic section formed in the manifold. Together the control system of the disc filter, along with a controller associated with the pressurized water supply unit is effective to actuate the high pressure media cleaning system and to cause it to automatically sequentially clean one section of filter units at a time.

Other objects and advantages of the present invention will become apparent and obvious from a study of the following description and the accompanying drawings which are merely illustrative of such invention.

### BRIEF DESCRIPTION OF THE DRAWINGS

FIG. 1 is a perspective view, viewed from the front, of the disc filter.

FIG. 2 is a perspective view of the disc filter, viewed from the back, with the housing and frame structure removed to better illustrate the disc-shaped filter units and portions of the high pressure media cleaning system.

FIG. 3 is a perspective cross-sectional view of the disc filter again with the housing and frame structure removed.

FIG. 4 is a cross-sectional view of the disc filter illustrating the movement of the spray bars of the high pressure media cleaning system during a cleaning operation.

FIG. 5 is a schematic illustration showing the pressurized water supply unit and portions of the disc filter, and particularly illustrating the relationship of the pressurized water supply unit and the sectioned manifold during a high pressure media cleaning operation.

FIG. 6 is a schematic illustration of the pressurized water supply unit.

FIG. 7 is a perspective view illustrating the sectioned manifold and the plurality of spray bars and associated nozzles that extend therefrom and which form a part of the high pressure media cleaning system.

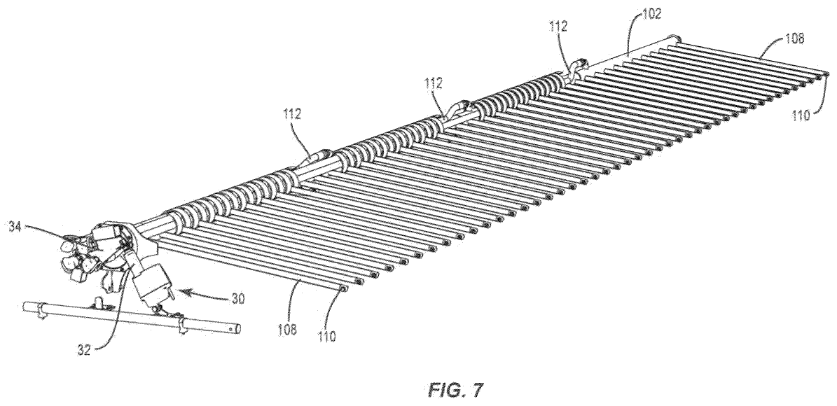

FIG. 8 is a plan view of a portion of the disc filter illustrating the sectioned manifold and the spray bars extending therefrom between respective filter units.

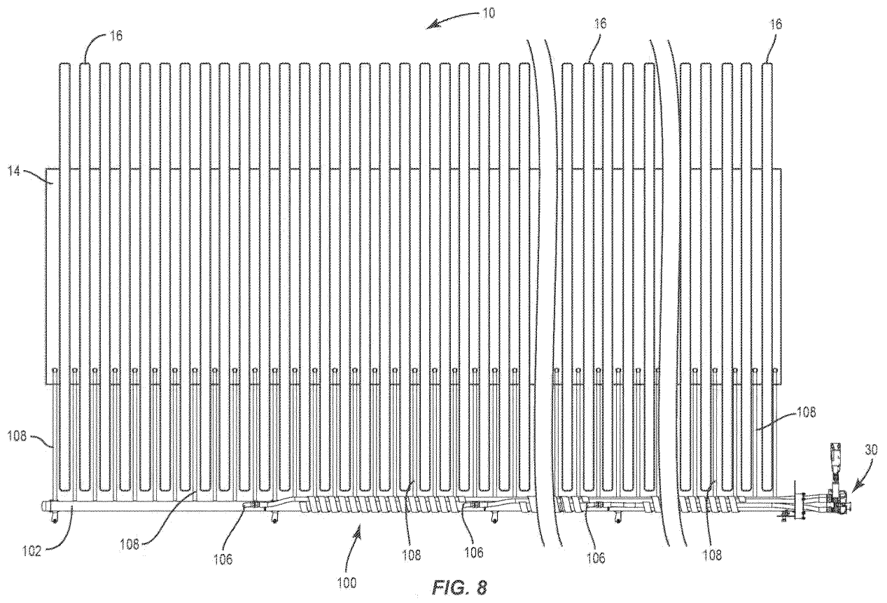

FIG. 9 is a view showing the actuator assembly used to rotate the sectioned manifold during a high pressure media cleaning operation.

### DESCRIPTION OF EXEMPLARY EMBODIMENTS

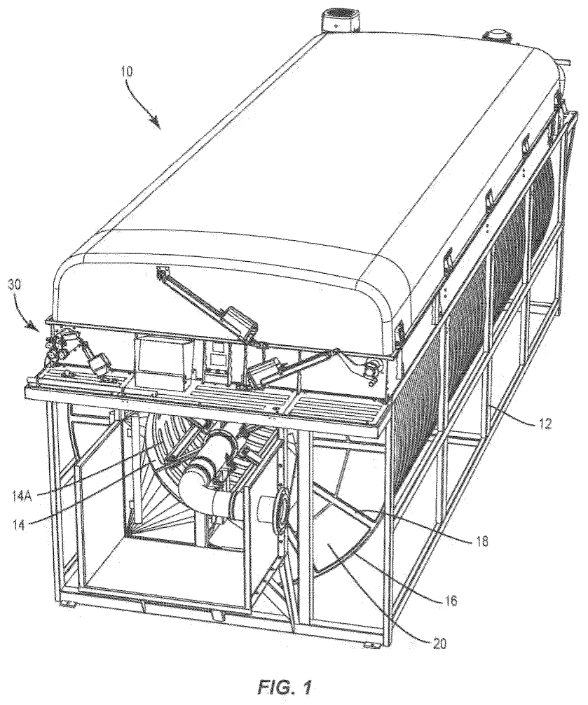

With further reference to the drawings, a rotary disc filter is shown therein and indicated generally by the numeral 10. As understood and appreciated by those skilled in the art, the rotary disc filter 10 is designed to filter suspended solids from wastewater. Disc filter 10 includes a main frame 12 that supports various components that make up the disc filter 10. In this regard, a drum 14 is rotatively mounted to the frame structure 12. Generally, the drum 14 is closed except that it includes an inlet opening about the front end of the disc filter and includes a series of openings 14A formed in the surface thereof. Secured to drum 14 is a series of disc-shaped filter members or units 16. As seen in the drawings (FIGS. 1-3), the filter units 16 are axially spaced along the drum 12. The number of filter units 16 can vary. Each filter unit 16 includes a filter frame 18 that can be constructed of various materials. In the example shown in the drawings, the filter frame 12 comprises a modular plastic frame. For a more detailed understanding of a typical modular plastic frame, see, for example, U.S. Pat. No. 10,188,971, the disclosure of which is expressly incorporated herein by reference. Secured about opposite sides of each filter unit 16 is filter media. In the embodiment shown in the drawings, the filter media employed on each filter unit 16 is a plurality of media panels 20 that are easily attached and detached from the filter frame 18. Media panels 20, along with filter frame 18, form an open area or space inside the filter unit 16. This open area is communicatively connected to the interior of the drum 14 via openings 14A formed in the surface of the drum. Certain detailed design features of the disc filter are omitted from the drawings and the description herein because they are not per se material to the present invention. For a further understanding and appreciation of rotary disc filters, reference is made to U.S. Pat. Nos. 11,000,791 and 11,291,935, the disclosures of which are expressly incorporated herein by reference.

There are two basic types of rotary disc filters used to filter wastewater. These are referred to as inside-out disc filters and outside-in disc filters. In the case of an inside-out disc filter, the wastewater being treated is directed into the drum 14 and from the drum into the open area within the respective filter units 16. Once in the filter unit 16, the wastewater being treated is directed out of the filter units through the media panels 20 and in this process the wastewater is filtered. On the other hand, an outside-in disc filter operates by directing the wastewater being treated from the outside of the filter unit 16, through the filter media on the outside of the filter units into the area or space within the filter units. As the wastewater being treated passes through the filter media 20 into the filter units 16, the suspended solids therein are captured in the filter media 20. Described below is a high pressure media cleaning system employed to periodically clean the media. This high pressure media cleaning system is applicable to both outside-in and inside-out disc filters.

As noted above, in the course of filtering wastewater in either inside-out or outside-in disc filters, suspended solids contained in the wastewater are captured by the filter media 20. Thus, from time-to-time, the filter media 20 must be cleaned. Disc filter 10 includes two different systems for cleaning the filter media 20. As discussed more fully below, disc filter 10 includes a conventional backwash system, as well as a high pressure media cleaning system. Conventional backwash systems typically operate at a relatively low pressure, generally on the order of 6-10 bar. They are frequently employed in the course of filtering wastewater. It is not unusual for conventional backwashing to be implemented daily, if not more frequently, especially in treating wastewater having a relatively high concentration of suspended solids. But over time, conventional backwashing processes are insufficient to address clogging that typically occurs over time. That is, over time it is not unusual for disc filters to experience long term clogging and this causes the filter media to lose its capacity to effectively and efficiently filter the wastewater. More aggressive cleaning (i.e., high pressure cleaning) is required to rejuvenate or restore the filter media 20 to where it performs at an optimum or acceptable level. Hence, the disc filter of the present invention is provided with a high pressure media cleaning system that is described more fully below. “High pressure” as used herein means a pressure significantly greater than the 6-10 bar pressure that is typically employed in conventional disc filter backwashing systems. The term “high pressure” as used herein means a pressure that is equal to or greater than 20 bar. It is noted that high pressure media cleaning systems are used less frequently than conventional media backwashing systems. While the frequency that high pressure media cleaning systems are employed can vary depending on the makeup of the wastewater and the efficiency of upstream processes, in some cases high pressure media cleaning might only be employed monthly.

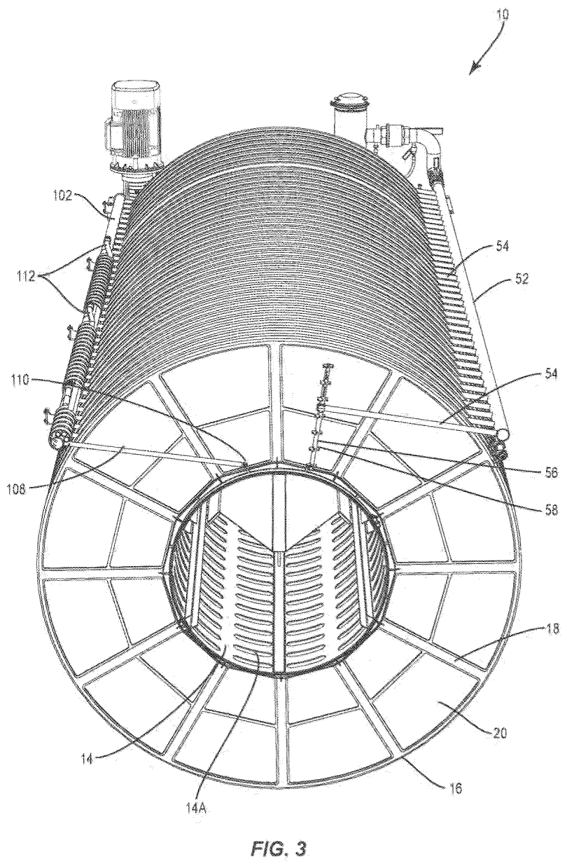

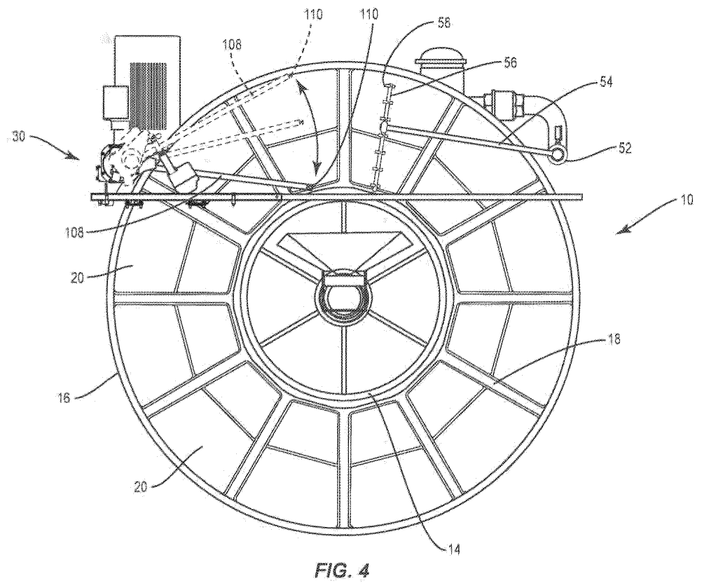

Prior to discussing the high pressure media cleaning system, a brief discussion of the backwashing system is appropriate. The backwashing system includes a backwash pump (not shown), an elongated manifold 52 that extends along a side portion of the disc filter 10, and a series of feed pipes or spray bars 54 that are connected to the manifold 52 and project inwardly therefrom between the respective filter units 16. See FIGS. 3-4. Secured to the remote end of the spray bars 54 are a series of nozzle holders indicated generally by the numeral 56. Nozzle holders 56 are designed to support detachable nozzles 58. In a backwashing operation, the backwash pump pumps a backwash from a backwash source, such as the filtered water, into and through the manifold 52. From the manifold 52, the backwash is pumped into the respective spray bars 54 and from the spray bars into and through the nozzles 56.

Manifold 52 in the embodiment illustrated is rotatively mounted along one side of the disc filter 10. Various drive means can be employed to rotate manifold 52. In some cases, manifold 52 is operatively connected to a drive (not shown) that can be indirectly driven off the drum motor 22 or by a motor that is dedicated to rotating the manifold. In any event, the manifold 52 during a backwashing operation typically rotates back and forth, which results in the nozzles 58 sweeping back and forth between the filter media 20 of adjacent filter units 16 so as to backwash the filter media disposed on opposite sides of the nozzles. For a more detailed discussion of backwashing systems used on disc filters, see the disclosures in U.S. Pat. Nos. 11,000,791 and 11,291,935.

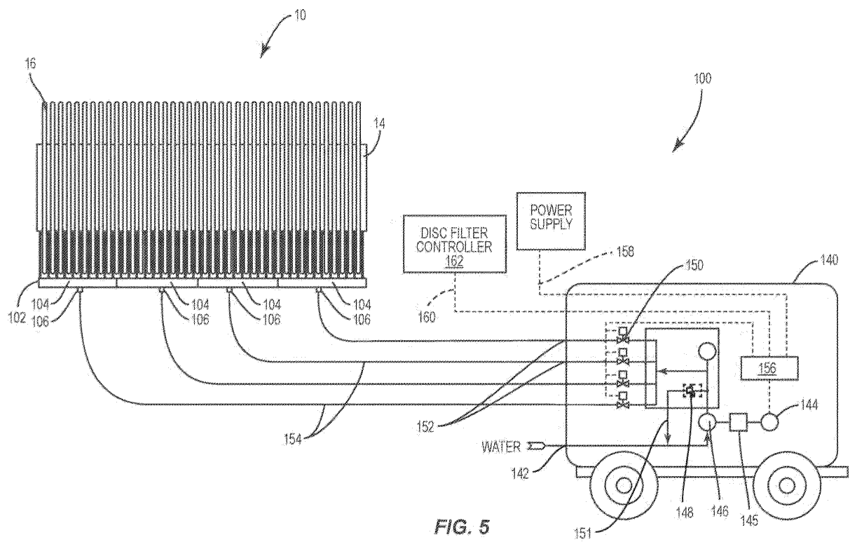

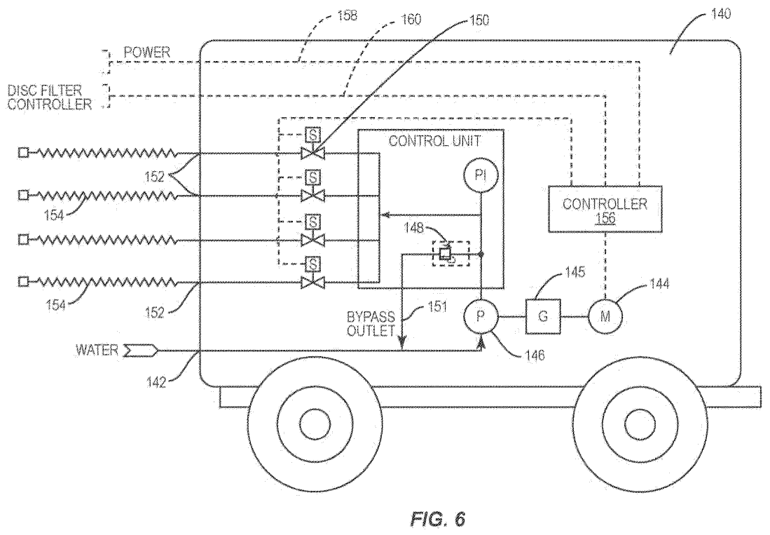

Continuing to refer to the drawings, the high pressure media cleaning system of the present invention is shown therein and indicated generally by the numeral 100. See FIGS. 5-6. High pressure media cleaning system 100 is designed to perform a high pressure cleaning operation on the media 20 of one section of the filter units 16 at one time. In one embodiment, as discussed below, the high pressure media cleaning system is automatically controlled to sequentially clean different sections of the filter unit 16, one after another.

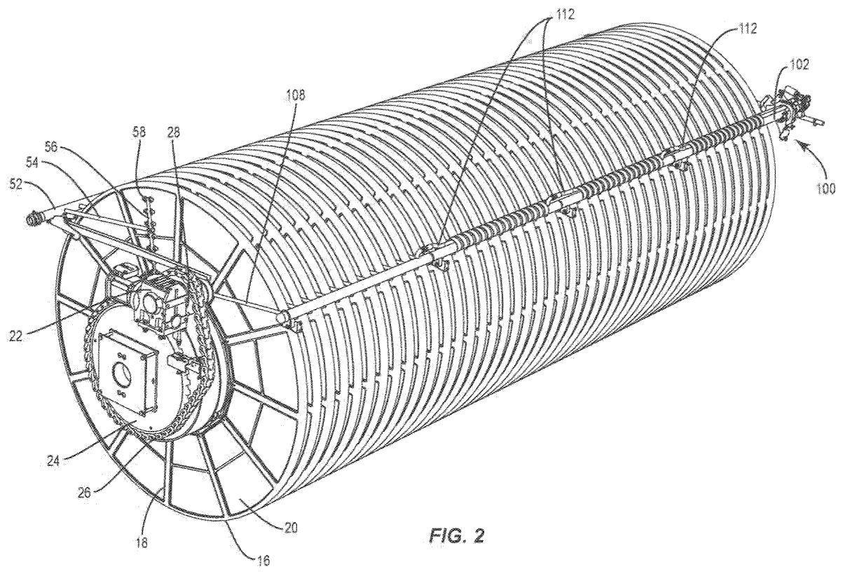

Viewing the high pressure media cleaning system 100 in more detail, it includes a sectioned manifold 102. Sectioned manifold 102 is rotatively mounted along one side of the disc filter 10 opposite the manifold 52 that forms a part of the backwashing system. See FIGS. 2-3. Sectioned manifold 102 is divided into a plurality of hydraulic sections 104, See FIG. 5. Each hydraulic section 104 is isolated from the other hydraulic section or sections and includes a pressurized water inlet 106. Communicatively connected to each hydraulic section 104 is a plurality of elongated spray bars 108. Spray bars 108 are also supported on the manifold 102 and extend therefrom to where the spray bars project between adjacent filter units 16. See FIGS. 3-5. Provided on the terminal end of most spray bars 108 is a pair of nozzles 110, with the pair of nozzles being directed in opposite directions. Since the spray bars disposed on the extreme ends of the disc filter 10 will only have to clean one side of one filter unit 16, those spray bars will only include one nozzle.

Extending along portions of the sectioned manifold 102 is a series of supply hoses or conduits 112. Each conduit 112 is connected to a pressurized water inlet 106 of one of the hydraulic sections 104. Conduits 112 extend together along the sectioned manifold 104 to one end (the front end in the embodiment shown) of the disc filter 10 where they terminate. The terminal ends may be provided with appropriate couplings that allow each to be quickly connected to a flexible supply hose that extends from the pressurized water supply unit to be discussed below. Since the sectioned manifold 102 is rotated during cleaning so as to articulate the respective spray bars 108, the supply conduits 112 are secured about the sectioned manifold so that the sectioned manifold and the supply conduits rotate as a unit.

Effectively, each hydraulic section 104 and the spray bars communicatively connected thereto are only responsible for cleaning one section of the filter unit 16. The term “section” as it pertains to the filter units 16 does not necessarily mean that the whole of any filter unit 16 must lie in one particular section. In some cases, one nozzle of a spray bar 108 may clean one side of a filter unit that lies in one section and the other nozzle of the same spray bar may clean one side of another filter unit that lies in an adjacent section.

During high pressure media cleaning, drum 14 and the filter units 16 thereon are rotated. As seen in FIG. 2, a drum motor 22 is mounted on the backside of the disc filter 10 and is employed to rotate the drum 14 and the filter units 16 mounted thereon. Various drive arrangements can be used to rotate the drum 14. In the embodiment illustrated in FIG. 2, the drive for driving the drum 14 comprises a driven sprocket 24 connected directly or indirectly to the drum 14. A chain 26 is trained around a drive sprocket 28 that is connected to the motor 22, as well as sprocket 24. Hence, the actuation of motor 22 drives sprockets 26 and 28, which in turn rotates drum 14 and the filter units 16 mounted thereon.

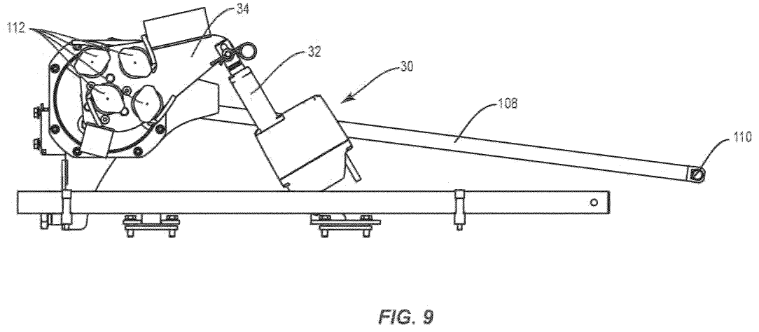

Since the spray bars 108 are fixed to the sectioned manifold 102, it follows that the spray bars are articulated and move back and forth along side of the media panels 20 by simply rotating the sectioned manifold. Hence, the sectioned manifold 102 is bearinged at a number of points along its length. As previously noted, the supply conduits 112 that extend along the length of portions of the sectioned manifold 102 are secured about the sectioned manifold so that the sectioned manifold and the supply conduits rotate together as a unit. To rotate the sectioned manifold 102 and the associated supply conduits 112, there is provided about the front end of the disc filter 10 an actuator assembly indicated generally by the numeral 30. Actuator assembly 30 comprises a linear actuator 32 anchored at one end to the frame structure of the disc filter 10. See FIGS. 1 and 9. Connected at the other end to the linear actuator 32 is an actuating arm 34. Actuating arm 34 extends from the linear actuator 32 and is operatively connected to the sectioned manifold 102, as well as the supply conduits 112. As viewed in FIGS. 3 and 4, extending the linear actuator 32 causes the sectioned manifold 102 and the supply conduits 112 to rotate counterclockwise. This causes in the spray bars 108 that extend from the sectioned manifold 102 to move from an inner position adjacent the drum 14 to an outer position in the vicinity of the outer periphery of the filter units 16. Spray bars 108 and the nozzles 110 associated therewith can be brought back to the home position by retracting the linear actuator 32.

To supply pressurized water to the hydraulic sections 104 of the manifold 102, there is provided a pressurized water supply unit indicated generally by the numeral 140. See FIGS. 5 and 6. Pressurized water supply unit 140 is provided with a water inlet 142 and includes an electric motor 144 that drives a pump 146 via a gear box 145. To maintain a generally constant water pressure downstream of the pump 146, there is provided a constant pressure regulating valve 148 and an associated bypass line 151. Pressurized water discharged by pump 146 is split into a plurality of streams. Each stream is directed to a separate flow control valve 150 which in the case of the embodiment illustrated is a solenoid valve. Outputs from the flow control valves 150 form a plurality of outlets 152. A plurality of flexible hoses 154 can be connected between the outlets 152 and the inlets of the supply conduits 112 that feed pressurized water to the respective hydraulic sections 104 of the sectioned manifold 102.

Pressurized water supply unit 140 includes a programmed controller 156 for controlling various components and functions of the pressurized water supply unit. As seen in FIG. 6, controller 156 controls motor 144 and hence pump 146, as well as the flow control valves 150. Power is supplied to the controller 156 via a power cable 158. Controller 156 is also operatively connected to a disc filter programmed controller 162 via a signal line 160.

In the embodiment shown in FIG. 5, the controllers 156 and 162 can be programmed to automatically clean one section of the filter units 16 after another until the entire array of filter units have been cleaned. It is this case where the flow control valves 150 can be automatically sequenced to supply pressurized water to one hydraulic section 104 after another until all the sections of the filter units 16 have been cleaned. In another embodiment, however, a pressurized water supply unit may be provided with only one outlet. In this case, after cleaning one section of the filter units 16, the pressurized water supply unit can be disconnected and reconnected to another hydraulic section 104 to clean another section of the filter units 16. In this embodiment, there is no requirement for the pressurized water supply unit 140 to include flow control valves or any other component or controls necessary to provide automatic sequential cleaning of multiple sections of the filter units 16.

Controllers 156 and 162 can be programmed in a number of specific ways to execute an automated high pressure media cleaning process. In one example, the high pressure media cleaning process is initiated by the disc filter controller 162. Initiation can be manual or programmed. Upon initiation, the disc filter controller 162 actuates the drum motor 22 which causes the drum 14 and the filter unit 16 thereon to rotate. Disc filter 162 also actuates the linear actuator 32 which causes the sectioned manifold 102 to rotate back and forth which in turn causes the spray bars 108 and their nozzles 110 to move up and down adjacent the media panels 20, while the media panels and filter units 16 are rotating past the nozzles. Also, the disc filter controller 162 signals the pressurized water supply unit controller 156 to start motor 144. This results in the pump 146 pressurizing the inlet water and directing the pressurized water to the series of flow control valves 150 which are normally closed. The high pressure cleaning process begins as a result of the controller 156 opening the first flow control valve. This results in pressurized water being directed through that flow control valve and out one of the outlets 152 and into one of the hydraulic sections 104. Pressurized water in the hydraulic section 104 moves through the spray bars 108 that are communicatively connected thereto and out the associated nozzles 110. The pressurized water is emitted by the nozzles 110 onto the media panels 20 so as to dislodge suspended solids and generally clean the media panels. As noted before, while the pressurized water is being emitted by the nozzles 110, the spray bars 108 are moving adjacent the filter panels 20 as the filter panels are rotated past the nozzles.

The cleaning duration can vary. In one example, the cleaning duration is programmed to last approximately 20 minutes including pause time that takes into account the duty cycle of motor 144. In any event, once the first section of filter units 16 has been cleaned, the controller 156 closes the first flow control valve and opens a second flow control valve and allows pressurized water to flow through the second flows control valve to a second hydraulic section 104 for the purpose of cleaning a second section of the filter units 16. This process is continued until all of the sections have been subjected to the high pressure media cleaning process.

In one embodiment, the pressurized water supply unit 140, as shown in FIGS. 5 and 6, is mobile and not supported on the disc filter 10. This can be a significant advantage. This is because many disc filter sites include multiple disc filters 10. In these cases, one pressurized water supply unit 140 can be used to service all or many of the disc filters 10 that are operating on the site. In other embodiments, the pressurized water supply unit need not be mobile as it may be incorporated into the disc filter 10 or may be a non-mobile standalone unit. There are many other advantages of the high pressure media cleaning system described. One advantage compared to other approaches is the inherent reliability of the design of the high pressure media cleaning system described here and particularly the approach of providing a manifold with multiple hydraulic sections where each section is designated to clean one section of a group of filter units 16. This minimizes the number of flow control valves, conduits and fittings required. This is particularly beneficial in terms of cost for high capacity rotary disc filters that might, for example, include as many as 40 or more filter units.

The specification and claims use the term “configured to”. As used herein, the term “configured to” means “designed to” and does not mean “capable of”.

The present invention may, of course, be carried out in other specific ways than those herein set forth without departing from the scope and the essential characteristics of the invention. The present embodiments disclosed herein are therefore to be construed in all respects as illustrative and not restrictive and all changes coming within the meaning and equivalency range of the appended claims are intended to be embraced therein.

1-16. (canceled)

17. A rotary disc filter and a high pressure cleaning system for cleaning filter media associated with the disc filter, the disc filter configured to filter wastewater and comprising:
A. a rotary drum;
B. a drive for rotating the drum during a media cleaning operation;
C. a plurality of disc-shaped filter units mounted on the drum;
D. the filter units including the filter media for filtering the wastewater passing through the filter units;
E. wherein the high pressure cleaning system is configured to clean the filter media and includes:
i. an elongated manifold mounted on the disc filter and extending adjacent the filter units, the manifold including a plurality of hydraulic sections with each hydraulic section isolated from the other hydraulic section or sections;
ii. a plurality of spray bars configured to project between the filter units with each spray bar including at least one nozzle;
iii. the plurality of spray bars divided into groups with each group of spray bars being communicatively connected to one hydraulic section of the manifold such that each group of spray bars and the nozzles thereof are designated to clean one section of the filter units;
iv. a pressurized water supply unit including:
a. a pump;
b. a cleaning water inlet;
c. a plurality of cleaning water outlets with each cleaning water outlet configured to supply cleaning water to one of the hydraulic sections of the manifold;
d. a plurality of flow control valves configured to control the flow of cleaning water from the pressurized water supply unit to the plurality of hydraulic sections of the manifold;
e. each flow control valve configured to control the flow of cleaning water from one cleaning water outlet to one of the hydraulic sections of the manifold;
v. a control system configured to actuate at least one flow control valve at a time such that cleaning water is supplied from the pressurized water supply unit to one hydraulic section of the manifold and to at least one group of spray bars at a time; and
vi. wherein the filter media of different sections of the filter units is cleaned by actuating different ones of the flow control valves, causing pressurized cleaning water to be directed from the pressurized water supply unit into and through respective hydraulic sections of the manifold and into and through the spray bars, and the nozzles thereof, communicatively connected to the respective hydraulic sections.

18. The disc filter and high pressure media cleaning system of claim 17 wherein the control system is configured to sequentially clean one section of filter units after another by sequentially actuating one flow control valve after another.

19. The disc filter and high pressure media cleaning system of claim 17 wherein the pressurized water supply unit comprises a mobile frame that includes the pump, cleaning water outlets, and flow control valves, and wherein the mobile frame is not supported by the disc filter and is structurally independent of the disc filter.

20. The disc filter and high pressure media cleaning system of claim 19 further including a plurality of conduits operatively connected between the pressurized water supply unit and the hydraulic sections of the manifold, each conduit being communicatively connected to a different one of the flow control valves of the pressurized water supply unit and communicatively connected to a different one of the hydraulic sections of the manifold.

21. The disc filter and high pressure media cleaning system of claim 17 wherein the control system includes:
A. a first controller associated with the pressurized water supply unit and configured to control the pump and the flow control valves; and
B. a main controller associated with the disc filter and configured to actuate the first controller associated with the pressurized water supply unit.

22. The disc filter and high pressure media cleaning system of claim 17 wherein each group of spray bars is communicatively connected to a different hydraulic section of the manifold, and wherein each group of spray bars projects from a respective hydraulic section of the manifold into a position where the group of spray bars is effective to clean the filter media of one section of the filter units.

23. The disc filter and high pressure media cleaning system of claim 17 including a plurality of pressurized water supply conduits that extend along portions of the manifold with each pressurized water supply conduit configured to connect to a water inlet formed in a respective hydraulic section; and wherein the plurality of pressurized water supply conduits are secured to the manifold such that as the manifold is rotated during a cleaning operation, the plurality of water supply conduits rotates with the manifold.

24. A method of using high pressure to clean filter media of a disc filter where the filter media forms a part of a plurality of disc-shaped filter units mounted on a drum wherein the filter units are divided into at least first and second sections with each section including a plurality of filter units, the method comprising:
A. cleaning the media of a first section of the filter units by:
i. actuating a first flow control valve associated with a pressurized water supply unit and directing pressurized cleaning water from the pressurized water supply unit through the first flow control valve into a first hydraulic section of a manifold that extends adjacent the filter units;
ii. from the first hydraulic section of the manifold, directing the pressurized cleaning water into a first group of spray bars, having a first group of nozzles associated therewith, that project between respective filter units of the first section of filter units;
iii. rotating the drum and the first section of filter units thereon and spraying the pressurized cleaning water from the first group of nozzles onto the filter media of the first section of filter units;
B. after cleaning the media of the first section of filter units, cleaning the media of the second section of filter units by:
i. actuating a second flow control valve associated with the pressurized water supply unit and directing pressurized cleaning water from the pressurized water supply unit through the second flow control valve into a second hydraulic section, isolated from the first hydraulic section, of the manifold and into a second group of spray bars, having a second group of nozzles associated therewith, that project between the respective filter units of the second section of filter units; and
ii. rotating the drum and the second section of filter units mounted thereon and spraying the pressurized cleaning water from the second group of nozzles onto the filter media of the second section of filter units.

25. The method of claim 24 wherein the manifold is elongated and mounted on the disc filter adjacent the filter units, and wherein the first and second hydraulic sections are aligned in the manifold; and wherein the first hydraulic section is aligned with the first section of filter units and wherein the second hydraulic section is aligned with the second section of filter units.

26. The method of claim 25 wherein the first group of spray bars are communicatively connected to the first hydraulic section and project therefrom into areas adjacent the filter units of the first section; and wherein the second group of spray bars is communicatively connected to the second hydraulic section and project therefrom into areas adjacent the filter units of the second section.

27. The method of claim 24 wherein the pressurized water supply unit comprises a mobile cart that is not supported by the disc filter and which carries a pump and the first and second flow control valves.

28. The method of claim 27 wherein the pressurized water supply unit includes a first controller configured to control the pump and the first and second flow control valves; and
wherein the first controller is communicatively connected to a main controller associated with the disc filter and wherein the main controller is configured to actuate the first controller for controlling the cleaning of the media of the first and second sections of the filter units.

29. The method of claim 24 wherein during the cleaning of the media of the first and second sections of the filter units, the manifold is rotated, causing the spray bars connected to the hydraulic sections of the manifold and the nozzles thereof to move along the sides of adjacent filter units for cleaning the media thereof.

30. A rotary disc filter and a high pressure media cleaning system for cleaning filter media associated with the disc filter, the disc filter configured to filter wastewater and comprising:
A. a rotary drum;
B. a drive for rotating the drum during a media cleaning operation;
C. a plurality of disc-shaped filter units mounted on the drum with each filter unit including filter media for filtering the wastewater passing through the filter units;
D. wherein the high pressure cleaning system is configured to clean the filter media and includes:
i. an elongated manifold mounted on the disc filter and extending adjacent the filter units;
ii. a plurality of hydraulic sections formed in the manifold with each hydraulic section being isolated with respect to the other hydraulic section or sections;
iii. each hydraulic section including an inlet for enabling pressurized water to be directed into the hydraulic section;
iv. a plurality of spray bars that project from the manifold into areas between the filtered units with each spray bar including at least one nozzle;
v. the plurality of spray bars divided into groups with each group of spray bars including a plurality of spray bars that are communicatively connected to only one hydraulic section of the manifold such that each group of spray bars and the nozzles thereon are designated to clean only one section of the filter units where one section includes a plurality of filter units but not all of the filter units of the disc filter;
vi. a pressurized water supply unit configured to be connected to one of the inlets of one of the hydraulic sections and to supply pressurized water to the one hydraulic section associated with said one inlet;
vii. wherein the filter media associated with the filter units of one section is cleaned by directing pressurized water from the pressurized water supply unit into the hydraulic section from which the pressurized water flows through the associated spray bars and is emitted against the filter media for the purpose of cleaning the filter media of one section of the filter units.

31. The disc filter and high pressure media cleaning system of claim 30 wherein each isolated hydraulic section is transversely aligned with one section of filter units.

32. The disc filter and high pressure media cleaning system of claim 30 wherein the spray bars are rigidly connected to the manifold and wherein the manifold, during a cleaning operation, is operative to rotate, which results in the spray bars moving along the sides of the filter units during the cleaning operation.

33. The rotary disc filter and high pressure media cleaning system of claim 30 wherein pressurized water supply unit comprises a mobile frame that includes a pump, cleaning water outlets, and a series of flow control valves, and wherein the mobile frame is not supported by the disc filter and is structurally independent of the disc filter.

34. The rotary disc filter and high pressure media cleaning system of claim 33 further including a plurality of conduits operatively connected between the pressurized water supply unit and the hydraulic sections of the manifold, each conduit being communicatively connected to a different one of the flow control valves of the pressurized water supply unit and communicatively connected to a different one of the hydraulic sections of the manifold.

35. The rotary disc filter and high pressure media cleaning system of claim 30 wherein the pressurized water supply unit includes:
A. a pump;
B. a cleaning water inlet;
C. a plurality of cleaning water outlets with each cleaning water outlet configured to supply cleaning water to one of the hydraulic sections of the manifold;
D. a plurality of control valves configured to control the flow of cleaning water from the pressurized water supply unit to the plurality of hydraulic sections of the manifold; and
E. wherein each flow control valve is configured to control the flow of cleaning water from one cleaning water outlet to one of the hydraulic sections of the manifold.

36. The rotary disc filter and high pressure media cleaning system of claim 35 further including a control system configured to actuate at least one flow control valve at a time such that cleaning water is supplied from the pressurized water supply unit to one hydraulic section of the manifold and to at least one group of spray bars at a time; and
wherein the filter media of different sections of the filter units is cleaned by actuating different ones of the flow control valves and causing pressurized cleaning water to be directed from the pressurized water supply unit into and through respective hydraulic sections of the manifold and into and through the spray bars, and the nozzles thereof, communicatively connected to the respective hydraulic section.
